(19) United States
(12) Patent Application Publication
(10) Pub. No.: US 2023/0192324 A1
(43) Pub. Date: Jun. 22, 2023

(54) MMOD PROTECTION STRUCTURES FOR AEROSPACE VEHICLES, ASSOCIATED SYSTEMS, AND METHODS

(71) Applicant: Blue Origin, LLC, Kent, WA (US)

(72) Inventors: Weidong Song, Woodinville, WA (US); Michael James Brennan, Renton, WA (US)

(21) Appl. No.: 17/555,035

(22) Filed: Dec. 17, 2021

(51) Int. Cl. B64G 1/56; B64G 1/40; B32B 3/12; B32B 5/18; B32B 5/24; B32B 15/04; B32B 15/14; B32B 15/20; B32B 27/06; B32B 27/12; B32B 27/20; B32B 27/38; B32B 7/12

(52) U.S. Cl. CPC B64G 1/56; B32B 3/12; B32B 5/18; B32B 5/245; B32B 7/12; B32B 15/14; B32B 15/20; B32B 15/046; B32B 27/12; B32B 27/20; B32B 27/38; B32B 27/065; B64G 1/40; B32B 2262/101; B32B 2266/0278; B32B 2605/18

(57) ABSTRACT

Space vehicles configured with a micrometeoroid and orbital debris (MMOD) protection system are described herein. The MMOD protection system can include (a) a front face sheet and a rear face sheet spaced apart from the front face sheet directed outwardly, and the rear face sheet being positioned to attach to the space launch vehicle; (b) at least one absorption core layer and at least one impact resistant fabric layer positioned between the front face sheet and the rear face sheet; and (c) an expandable adhesive layer carried by the rear face sheet to attach the MMOD protection system to the space launch vehicle. The front face sheet and the rear face sheet can comprise a metal matrix composite. The MMOD protection system can protect the space vehicle from damage in space, while withstanding launch loads, and can accordingly eliminate the need for a protective launch fairing.

### TECHNICAL FIELD

The present technology relates generally to micrometeoroids and orbital debris (MMOD) protection systems/structures for use in aerospace systems, including those in off-Earth orbit.

### BACKGROUND

One hazard associated with spaceflight generally and orbiting objects in particular is collisions with micrometeoroids and orbital debris (MMOD). Accordingly, protection for exposed equipment surfaces associated with orbiting habitats, spacecraft, space-borne instruments, space stations and fuel depots is critical to mission safety and success. There are numerous documented cases of MMOD damage causing critical equipment mission impairment or failure in space. Moreover, the risk of damage to equipment from orbital debris steadily increases with the ever-increasing amount of orbital debris placed in orbit from space missions and space defense operations.

Protection schemes have been developed to protect spacecraft from MMOD. In general, systems to be placed in orbit outside the Earth’s atmosphere can be either assembled on earth and transported into orbit, or assembled in orbit from individual parts transported from Earth. However, both approaches have disadvantages that limit the ability to provide MMOD protection. In a typical example, the spacecraft (e.g., a satellite, orbital habitat, or space probe) is launched as a payload inside a fairing mounted onto the launch system. The fairing protects the payload from the external environment during launch, but is then separated when the launch vehicle reaches a target condition, such as a target altitude, thus exposing the payload to the exterior environment. If the MMOD protection is placed on the payload before launch, the MMOD protection system must survive the launch loads, which adds mass to the overall system and requires a more complex design of the MMOD protection system. If the MMOD protection is added to the payload after the payload is in space, the added assembly process requires extravehicular activity (e.g., spacewalks), which is difficult and dangerous and thus, undesirable.

Accordingly, there remains a need for more efficient and economical MMOD protection systems/structures.

### BRIEF DESCRIPTION OF THE DRAWINGS

Many aspects of the present technology can be better understood with reference to the following drawings. The components in the drawings are not necessarily to scale. Instead, emphasis is placed on clearly illustrating the principles of the present technology.

FIG. 1 is a schematic cross-sectional view of an MMOD protection structure 100 configured in accordance with embodiments of the present technology.

FIGS. 2A-2B show representative image an absorption core layer of an MMOD protection structure configured in accordance with embodiments of the present technology.

FIG. 3 is a schematic cross-sectional view of an MMOD protection structure of FIG. 1 bonded to a space launch vehicle in accordance with embodiments of the present technology.

FIG. 4 is a schematic cross-sectional view of an MMOD protection structure 400 configured in accordance with embodiments of the present disclosure.

FIGS. 5A-5B is a schematic cross-sectional view of an MMOD protection structure 500 configured in accordance with embodiments of the present disclosure.

FIGS. 6A-6D is a schematic cross-sectional view of an MMOD protection structure 600 configured in accordance with embodiments of the present disclosure.

FIG. 7 is a schematic of an MMOD protection structure bonded to a space vehicle configured in accordance with embodiments of the present disclosure.

FIG. 8 schematic diagram illustrating a mission profile of a launch vehicle including an MMOD protection structure configured in accordance with embodiments of the present technology.

### DETAILED DESCRIPTION

Aspects of the present technology are directed generally to structures/systems that prevent damage from micrometeoroids and orbital debris (MMOD). In general, MMOD systems can include MMOD protection structures, alone or in combination with other elements (e.g., orbital vehicles). MMOD protection structures in accordance with embodiments of the present technology can be installed prior to launch and do not need protection from a payloads fairing, thus simplifying the launch system and reducing launch mass. Such structures are desirable, and in some cases required, to protect spacecraft from damage once outside the Earth’s atmosphere. In several of the embodiments described below, the MMOD protection structure includes a front face sheet and a rear face sheet, with the front face sheet directed towards a region of ballistic threat (e.g., facing outwardly) to protect a space vehicle, and a rear face sheet (e.g., facing inwardly). The rear face sheet can be an outer shell of the space vehicle (e.g., an exterior wall of the vehicle). The MMOD protection structure can also include at least one absorption core layer and at least one impact resistant fabric layer positioned between the front face sheet and the rear face sheet. The front face sheet and rear face sheet can include a metal matrix composite material (e.g., an aluminum matrix composite), a polymer composite material (e.g., fiberglass reinforced epoxy composites), and/or a metal face sheet (e.g., an aluminum sheet). In some embodiments, the MMOD protection structure includes an expandable adhesive layer between the space vehicle and the rear face sheet which can improve the structural performance of the MMOD protection structure.

The components of the MMOD protection structure described herein can provide improvements over conventional MMOD protection structures, for example, by eliminating the need for a payload fairing during launch, and/or eliminating the need for complex operations in space to install MMOD protection structures after the space vehicle is launched. Instead, the MMOD structure can, in addition to protecting the payload (e.g., a spacecraft) from MMOD once in space, also operate to protect the spacecraft from pressure loads and/or thermal loads during launch, thus eliminating the need for a fairing. This in turn reduces system mass, which can reduce the amount of propellant necessary to carry out the mission, and/or increase the mass available for the payload. This approach can also eliminate the need to install MMOD system to a spacecraft that is already in space, because the MMOD protection structure is attached to the spacecraft prior to launch.

As described in further detail below, the metal matrix composite material, polymer composite material, and/or metal sheets of the front face sheet and rear face sheet of the MMOD protection structure can increase the strength and robustness of the MMOD protection structure, while maintaining a low mass. Integrating a low-density energy absorbing core layer in between impact-resistant fabric layers allows the MMOD protection structure to withstand dynamic and static loads experienced by the space vehicle, in particular during launch, even without a fairing.

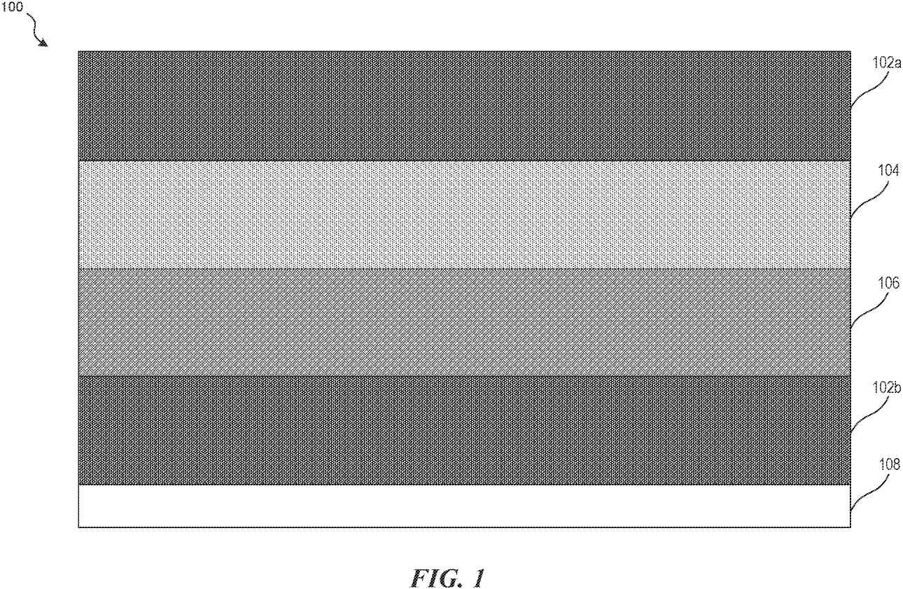

Certain details are set forth in the following description and in FIGS. 1-8 to provide a thorough understanding of various embodiments of the present technology. Those of ordinary skill in the art will recognize, however, that the present technology can be practiced without one or more of the details set forth herein, and/or with other structures, components, and so forth. Additionally, although the MMOD protection structure of the illustrated embodiments is a space vehicle structure, the systems and/or structures disclosed herein can also be used for other types of structures, such as other types of pressure vessels, hypersonic vehicles, aircraft, surface ships and/or underwater vehicles. Accordingly, the present technology is not necessarily limited to space vehicle structures.

The accompanying Figures depict embodiments of the present technology and are not intended to limit the scope of the present technology unless expressly stated. The sizes of various depicted elements are not necessarily drawn to scale, and these various elements may be enlarged to improve legibility. Component details may be abstracted in the Figures to exclude details such as the position of components and certain precise connections between such components when such details are unnecessary for a complete understanding of how to make and use the present technology. Many of the details, dimensions, angles, and other features shown in the Figures are merely illustrative of particular embodiments of the technology. Accordingly, other embodiments can have other details, dimensions, angles, and features without departing from the present technology. In addition, those of ordinary skill in the art will appreciate that further embodiments of the present technology can be practiced without several of the details described below.

As used herein, the terms “space vehicle” and “aerospace vehicle” refer generally to vehicles that travel in space. Such vehicles may also travel through the Earth’s atmosphere. The terms “launch vehicle” and “space launch vehicle” refer generally to a vehicle that launches and/or boosts a payload, e.g., from the Earth’s surface. Launch vehicles, however, may also have longer-term utility in space, for example, when used as a habitat after launch, and/or if used as a single stage to orbit (SSTO) vehicle. The term “payload” refers generally to a device that performs a mission in space, e.g., a satellite, an orbital habitat, a converted launch vehicle, and/or a (crewed or uncrewed) space probe. The term “space system” refers generally to a system that includes a space vehicle.

FIG. 1 is a schematic cross-sectional view of a representative MMOD protection structure 100 configured in accordance with embodiments of the present technology. In the illustrated embodiment, the MMOD protection structure 100 includes a first face sheet 102a spaced apart from a second face sheet 102b (sometimes referred to collectively as “face sheets 102”). Alternating intermediate layers are positioned between the first face sheet 102a and second face sheet 102b, and can include at least one absorption core layer 104 and at least one impact resistant fabric layer 106. In some embodiments, the MMOD protection structure 100 further includes an expandable adhesive layer 108 to bond the MMOD protection structure 100 to a space vehicle, e.g., an orbital habitat or a launch vehicle (or launch vehicle stage) that may operate as an orbital habitat once in space.

In some embodiments, the MMOD protection structure 100 includes multiple and alternating stacked absorption core layers 104 and impact resistant fabric layers 106 sandwiched between the first face sheet 102a and second face sheet 102b. For example, the MMOD protection structure 100 can include at least one, at least two, at least three, at least four, at least five, at least six, at least seven, at least eight, at least nine, at least ten, or more absorption core layers 104 and/or impact resistant fabric layers 106, where the absorption core layers 104 are positioned between the resistant fabric layers 106.

The face sheets 102 can comprise a metal matrix composite material, a polymer composite material, and/or a metal face sheet. These materials are impact-resistant (to provide MMOD protection), relatively light mass and/or low density (to reduce mass), and can also withstand the high temperatures to which the space vehicle may be exposed during launch, while thermally insulating the space vehicle to which it is attached. The materials can also protect the space vehicle from radiation at high altitudes and/or in space.

As used herein, a metal matrix composite includes a material comprising continuous reinforcing fibers in a matrix of metal, with the continuous fibers infiltrated within the matrix metal. In some embodiments, the fibers include aluminum oxide, glass, quartz, carbon, and/or other similar fibers. The matrix metal can include any castable metal or metal alloy that is compatible with the selected fibers. For example, in some embodiments, the matrix metal may include aluminum, magnesium, copper, zinc, and/or iron, and/or alloys thereof.

The metal matrix composite material can comprise an aluminum matrix composite material. In some embodiments, the aluminum matrix composite comprises a pure aluminum matrix such as the commercially available MetPreg™ tape, a fiber-reinforced aluminum material including a commercially-pure aluminum (AI-1100) matrix reinforced with 50 volume percent continuous Nextel™ 610 alumina fibers.

As used herein, a polymer composite material incudes a material comprising short or continuous fibers bound together by an organic polymer. The organic polymer can be or include, for example, an epoxy that binds the fibers together thereby, reinforcing the structure. In some embodiments, the polymer composite material comprises fiberglass reinforced epoxy composites. Non-limiting examples of suitable polymer composite materials include graphite/epoxy, Kevlar®/epoxy, and/or boron/epoxy composites.

As used herein, a metal sheet refers to a sheet of metal that is lightweight, strong, and/or resistant to corrosion. The metal sheet can comprise aluminum, an aluminum alloy, other metallic material(s), and/or alloy. Non-limiting examples of suitable metal sheets include aerospace grade aluminum such as aluminum 6061, aluminum 2024, aluminum 7075, and/or aluminum 7050.

A thickness of the face sheets 102 can be between about 0.01 inches to about 0.5 inches. For example, the face sheets 102 can have a thickness of about 0.01 inches, about 0.02 inches, about 0.03 inches, about 0.04 inches, about 0.05 inches, about 0.1 inch, about 0.15 inch, about 0.2 inches, about inches, about 0.3 inches, about 0.35 inches, about 0.4 inches, about 0.45 inches or about 0.5 inches. In certain embodiments, the face sheets 102 include a metal matrix composite material comprising an aluminum matrix composite material having a thickness of about 0.1 inches.

A density of the face sheets 102 can be between relatively low: e.g., about 0.01 pounds per cubic inch (lb/in³) to about 0.02 lb/in³ of material. For example, the face sheets 102 have a density of about 0.01 pounds per cubic inch (lb/in³), about 0.05 lb/in³, about 0.1 lb/in³, about 0.11 lb/in³, about 0.12 lb/in³, about 0.13 lb/in³, about 0.14 lb/in³, about 0.15 lb/in³, about 0.16 lb/in³, about 0.17 lb/in³, about 0.18 lb/in³, about 0.19 lb/in³, or about 0.2 lb/in³ of material. In certain embodiments, the face sheets 102 include a metal matrix composite material comprising an aluminum matrix composite material having a density of about 0.12 lb/in³ of material.

A mass of the face sheets 102 can be between about 1 pound per square foot (lb/ft²) to about 2 lb/ft² of material. For example, the face sheets 102 have a mass of about 1 lb/ft², about 1.2 lb/ft², about 1.3 lb/ft², about 1.4 lb/ft², about 1.5 lb/ft², about 1.6 lb/ft², about 1.7 lb/ft², about 1.8 lb/ft² , about 1.9 lb/ft², or about 2 lb/ft² of material. In certain embodiments, the face sheets 102 comprise a metal matrix composite material comprising an aluminum matrix composite material having a mass of about 1.7 lb/ft² of material.

In some embodiments, the face sheets 102 comprise an aluminum matrix composite material having a thickness of about 0.04 inches to about 0.2 inches, a density of about 0.12 lb/in³ of material, and a mass of about 1.7 lb/ft² of material. In some embodiments, the face sheets 102 comprise pure aluminum (Al-1100) matrix reinforced with 50 volume percent continuous Nextel™ 610 alumina fibers (e.g., MetPreg™ tape).

The at least one absorption core layer 104 can comprise a low density, compressible material including foam material and/or honeycomb material. The low density material (e.g., foam) provides a light-mass, low-cost, efficient way to space and support the at least one impact resistance fabric layer 106 of the MMOD protection structure 100 by serving as a shock absorbing layer during and after launch. In some embodiments, the foam material comprises “space-rated” foam such as solomide foam, polymide foam, or a polyurethane foam that is qualified for spacecraft applications. In another embodiment, the honeycomb material comprises aramid paper, polymer films, or metal foil such as aluminum core.

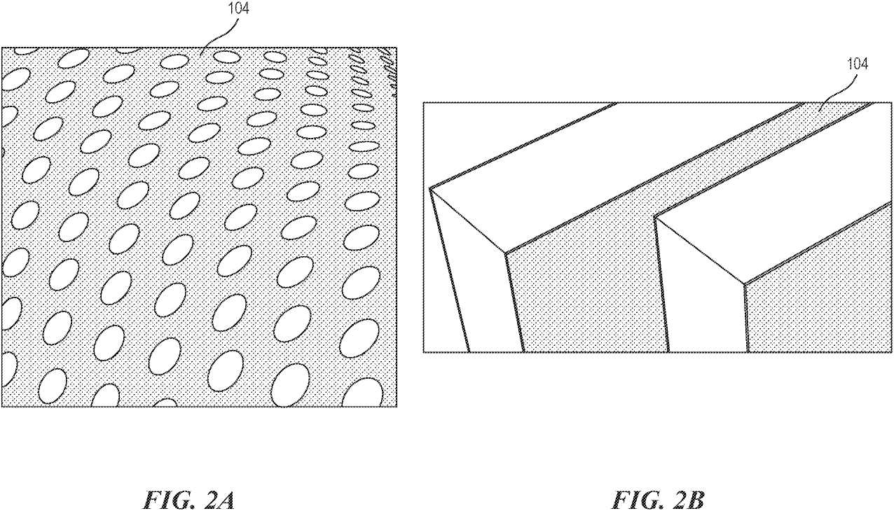

The foam material can be perforated. For example, the foam material can be perforated when portions of the foam material are cored out to achieve a lighter mass foam material which can in turn enhance dispersion of broken orbital debris. The foam can be perforated by puncturing and removing portions of the foam material. In some embodiments, the foam material is perforated by introducing discrete holes into the foam material (FIG. 2A). In other embodiments, the foam is perforated by introducing a network of laterally and/or longitudinally extending tunnels into the foam material. In certain embodiments, the foam material comprises perforated polyurethane foam such as the commercially available LAST-A-FOAM® EF-4000 shown in FIGS. 2A-2B.

A thickness of the absorption core layer 104 can be between about 0.5 inches to about 6 inches or more. For example, the absorption core layer 104 can have a thickness of about 0.5 inches, about 1 inch, about 1.5 inches, about 2 inches, about 2.5 inches, about 3 inches, about 3.5 inches, about 4 inches, about 4.5 inches, about 5 inches, about 5.5 inches, or about 6 inches.

A density of the absorption core layer 104 can be between about 1 lb/ft³ to about 4 lb/ft³ of material. For example, the absorption core layer 104 can have a density of about 1 lb/ft³, about 1.5 lb/ft³, about 2 lb/ft³, about 2.5 lb/ft³, about 3 lb/ft³, about 3.5 lb/ft³, or about 4 lb/ft³ of material. In certain embodiments, the at least one absorption core layer 104 comprises polyurethane foam and can have a density of about 3 lb/ft³ of material.

A mass of the absorption core layer 104 can be between about 0.5 lb/ft² to about 3 lb/ft² of material. For example, the absorption core layer can have a mass of about 0.5 lb/ft², about 1 lb/ft², about 1.5 lb/ft², about 2 lb/ft², about 2.5 lb/ft², or about 3 lb/ft² of material. In certain embodiments, the at least one absorption core layer 104 comprises polyurethane foam and can have a mass of about 1 lb/ft² of material.

In some embodiments, the absorption core layer 104 comprises a perforated foam material having a density of about 3 lb/ft³ of material and a mass of about 1 lb/ft² of material. In some embodiments, the absorption core layer 104 comprises perforated polyurethane foam (e.g., LAST-A-FOAM® EF-4000).

The at least one impact resistant fabric layer 106 (FIG. 1) can comprise a material with a high ballistic modulus and/or resistance to damage from ballistic impact. The impact resistant fabric layer is capable of shocking hypervelocity particles (e.g., MMOD), resulting in the fragmentation of vaporization of the particles. In some embodiments, the at least one impact resistant fabric layer 106 comprises a high-strength fabric such as commercially available Nextel™, Kevlar®, or Spectra® fabric.

In certain embodiments, the at least one impact resistant fabric layer 106 comprises a ceramic oxide fiber material such as Nextel™. The at least one impact resistant fabric layer 106 can comprise greater than 99% Al₂O₃, referred to commercially as Nextel™. Alternatively, the at least one impact resistant fabric layer 106 comprises an aramid fiber such as Kevlar®. In some embodiments, the at least one impact resistant fabric layer 106 comprises poly-para-phenylene terephthalamide, referred to commercially as Kevlar® 59. The at least one impact resistant fabric layer 106 can also comprise a polyethylene fiber such as Spectra®.

A thickness of the at least one impact resistant fabric layer 106 can be between about 0.006 inches to about 0.15 inches. For example, the at least one impact resistant fabric layer 106 can have a thickness of about 0.006 inches, about 0.007 inches, about 0.008 inches, about 0.009 inches, about 0.01 inches, about 0.02 inches, about 0.03 inches, about 0.04 inches, about 0.05 inches, about 0.06 inches, about 0.07 inches, about 0.08 inches, about 0.09 inches, about 0.1 inches, about 0.11 inches, about 0.12 inches, about 0.13 inches, about 0.14 inches, or about 0.15 inches.

A mass of the at least one impact resistant fabric layer 106 can be between about 0.01 lb/ft² to about 0.1 lb/ft² of material. For example, the at least one impact resistant fabric layer 106 can have a mass of about 0.01 lb/ft², about 0.02 lb/ft², about 0.03 lb/ft², about 0.04 lb/ft², about 0.05 lb/ft², about 0.06 lb/ft², about 0.07 lb/ft², about 0.08 lb/ft², about 0.09 lb/ft², or about 0.1 lb/ft² of material. In some embodiments, the at least one impact resistant fabric layer 106 comprises Nextel™ 610 and can have a mass of about 0.1 lb/ft² of material. In other embodiments, the at least one impact resistant fabric layer 106 comprises Kevlar® 59 and can have a mass of about 0.04 lb/ft² of material.

The MMOD protection structure 100 (FIG. 1) can further include an expandable adhesive layer 108 to bond the MMOD protection structure 100 to a space vehicle, e.g., an orbital habitat or a launch vehicle. The expandable adhesive layer 108 improves the structural performance of the MMOD protection structure 100, allowing for increased survival of the space vehicle during and after launch. The improved structural performance of the MMOD is to withstand high G-loads during launch, and high impact loads once in space due to MMOD. The expandable adhesive layer 108 can expand when activated, thereby filling in the gap between the MMOD protection structure and space vehicle, increasing the overall performance of the MMOD protection structure. In certain embodiments, the expandable adhesive layer comprises an expandable adhesive foam material. The expandable adhesive layer can comprise PL-460 foaming adhesive, also known as Hysol PL460 or LOCTITE EA 460 AERO, which includes a foam epoxy adhesive; MA562 Grade 50 foaming adhesive also known as Hysol MA 562 or LOCTITE EF 562 AERO, which includes a curing foaming adhesive; and/or FM 490A GR50 foaming adhesive also known as Hysol MA 562, which includes an epoxy material provided in sheet form.

A mass of the expandable adhesive layer 108 can be between about 0.1 lb/ft² to 0.8 lb/ft² of material. In some embodiments, the expandable adhesive layer 108 comprises an expandable adhesive foam material having a mass of about 0.1 lb/ft², about 0.2 lb/ft², about 0.3 lb/ft², about 0.4 lb/ft², about 0.5 lb/ft², about 0.6 lb/ft², about 0.7 lb/ft², or about 0.8 lb/ft² of material.

In some embodiments, each of the layers of the MMOD protection structure 100 are adhered to each other using an adhesive. The adhesive can be a paste adhesive, film adhesive, or spray adhesive. In some embodiments, the adhesive is an epoxy or polyurethane adhesive. In some embodiments, the adhesive material comprises maleimide, bismaleimide, benzoxazine, cyanate ester, phenolic, polyimide, or combination thereof.

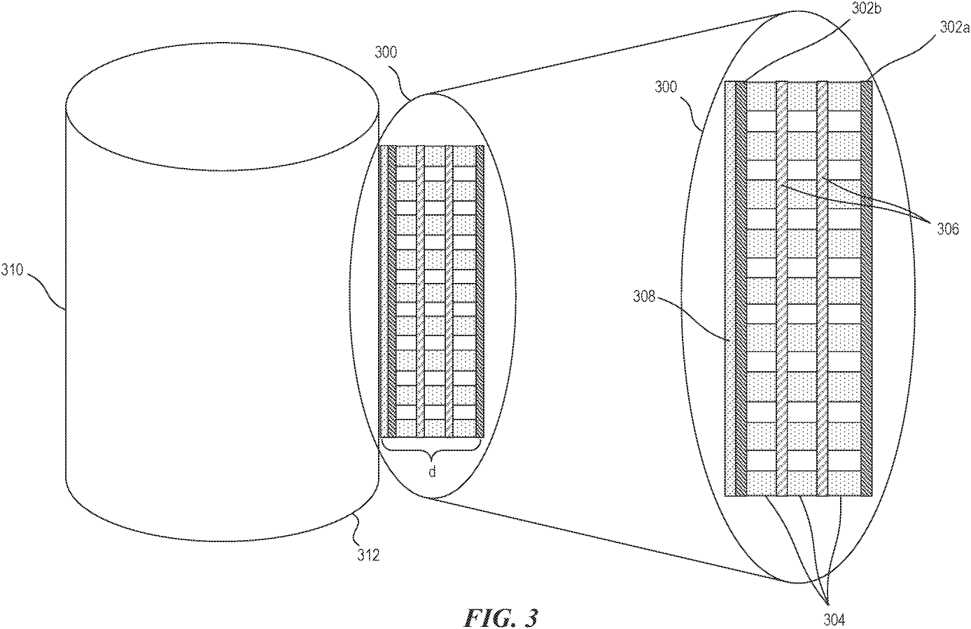

FIG. 3 illustrates a representative MMOD protection structure 300 (e.g., similar to the MMOD protection structure 100 of FIG. 1) bonded to a space vehicle 310, e.g., an orbital habitat and/or a launch vehicle, in accordance with embodiments of the present technology. In the illustrated embodiment, the space vehicle 310 includes a sub-structure 312, to which the MMOD protection structure is attached. Accordingly, the sub-structure can include any material conventionally used for a space vehicle structure, while the MMOD protection structure 300 forms at least part of the external surface of the space vehicle 310. Suitable materials for the sub-structure 312 include aluminum, titanium and/or alloys thereof, for launch vehicles and/or payloads. The MMOD protection structure 300 includes a first face sheet 302a (e.g., corresponding to the first face sheet 102a of FIG. 1) spaced apart from a second face sheet 302b (e.g., corresponding to the second face sheet 102b of FIG. 1) and intermediate layers including three absorption core layers 304 (e.g., corresponding to the absorption core layer 104 of FIG. 1) interleaved between two impact resistant fabric layers 306 (e.g., corresponding to the impact resistant fabric layers 106 of FIG. 1). In the illustrated embodiment, the MMOD protection structure 300 includes an expandable adhesive layer 308 (e.g., corresponding to the expandable adhesive layer 108 of FIG. 1) bonded to the space vehicle 310.

As a result of the support contributed by the MMOD protection structure, the MMOD protection structure can serve as a secondary structural support system, offsetting the mass and/or strength required of the sub-structure 312. For example, instead of attaching the MMOD protection structure to an existing sub-structure, the increased protection provided by the MMOD protection structure allows the sub-structure to have a lower mass and/or strength than it otherwise would. In some embodiments, reducing a mass and/or strength of the sub-structure 312 can include reducing a thickness of an external layer on the sub-structure 312.

In some embodiments, the first face sheet 302a is a front facing face sheet facing toward a region of ballistic threat (e.g., the external environment), and the second face sheet 302b is a rear face sheet adjacent to a space vehicle needing protection.

In certain embodiments, the distance (d) between the front face sheet 202a and the orbital habitat or other space vehicle (e.g., a “stand-off” distance) is between about 2 inches to about 8 inches. For example, the stand-off distance can be about 2 inches, about 2.5 inches, about 3 inches, about 3.5 inches, about 4 inches, about 4.5 inches, about 5 inches, about 5.5 inches, about 6 inches, about 6.5 inches, about 7 inches, about 7.5 inches, or about 8 inches.

In some embodiments, the space vehicle 310 includes a space station, a space station component, an orbital storage facility, an interplanetary spacecraft, a launch vehicle, a rocket vehicle, a rocket stage, and/or any component or combination thereof.

As discussed above, the MMOD protection structure can provide at least some of the structural integrity of the space vehicle or portion of the vehicle during and after launch. For example, the MMOD protection structure can provide structural support that helps the vehicle withstand the acceleration and vibrational loads produced during and after launch.

In some embodiments, the MMOD protection structure at least reduces the effects of a collision between the vehicle and e.g., a micro-meteor, during and after launch. In some embodiments, the space vehicle 310 (e.g., all or part of an orbital habitat) can be recovered, and reused for space launch operations due at least in part to the protection provided by the MMOD protection structure.

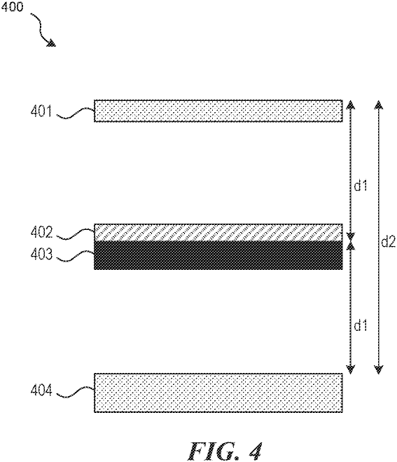

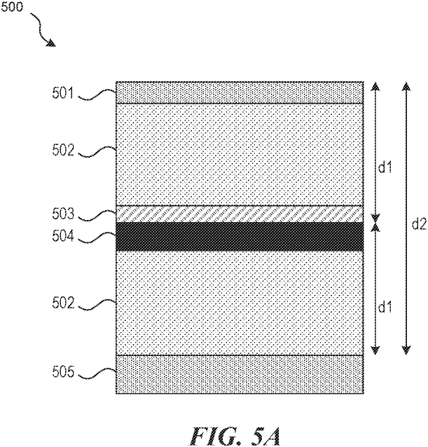

FIG. 4 is a schematic cross-sectional view of a representative MMOD protection structure 400 configured in accordance with embodiments of the present technology. In the illustrated embodiment, the MMOD protection structure 400 includes a front face sheet 401 and a rear face sheet 404, with the rear face sheet 404 comprising either a rear wall of a space vehicle or a face sheet bonded to an exterior wall of a space vehicle. Intermediate layers are positioned between the front face sheet 401 and rear face sheet 404, and can include a first impact resistant layer 402 and a second impact resistant layer 403. The first impact resistant layer 402 and the second impact resistant layer 403 can be adjacent to each other and separated from the front face sheet 401 and rear face sheet 404 by a space (e.g., a void). One or more studs and/or other support elements (not shown in FIG. 4) can support the various layers relative to each other thereby maintaining the spacing between the various layers.

A distance (d1) between the first impact resistant layer 402 and the front face sheet 401 can be about 1 inch, about 2 inches, about 3 inches, or about 4 inches. Similarly, a distance (d1) between the second impact resistant layer 403 and the rear face sheet 404 can be about 1 inch, about 2 inches, about 3 inches, or about 4 inches. The stand-off distance (d2) can be about 2 inches, about 3 inches, about 4 inches, or about 5 inches. In some embodiments, d1 is about 2 inches and d2 is about 4 inches.

A thickness of the front face sheet 401 can be about 0.04 inches to about 0.1 inches. For example, the front face sheet 401 can have a thickness of about 0.045 inches, 0.05 inches, 0.055 inches, 0.06 inches, 0.065 inches, 0.07 inches, about 0.075 inches, about 0.08 inches, about 0.085 inches, about 0.09 inches, or about 0.1 inches.

The dimensions of the front face sheet 401 can also differ relative to the dimensions of the impact resistant layers 402, 403 and/or the rear face sheet 404. For example, the front face sheet 401 can have a smaller length and/or width as compared to the impact resistant layers 402, 403 and/or the rear face sheet 404. In some embodiments, the front face sheet 401 can have a length and/or width of about 6 inches whereas one or more of the impact resistant layers 402, 403, and/or rear face sheet 404 can have a length and/or width greater than about 6 inches (e.g., about 7 inches, about 8 inches, about 9 inches, about 10 inches, about 11 inches, about 12 inches, or greater). The foregoing width dimensions were used for test articles, and can be used for actual shields as well. However, it is expected that the actual shields will typically have larger widths and/or lengths - e.g., from one to five feet. Such elements (e.g., tiles) can then be used to cover the entire surface or portions of the surface of a corresponding space vehicle.

A thickness of the rear face sheet 404 can be about 0.1 inches to about 0.2 inches. For example, the rear face sheet 404 can have a thickness of about 0.1 inches, 0.11 inches, 0.12 inches, 0.13 inches, 0.14 inches, 0.15 inches, about 0.16 inches, about 0.17 inches, about 0.18 inches, about 0.19 inches, or about 0.2 inches.

The impact resistant layers 402, 403 can comprise Nextel™, Kevlar®, fiberglass (e.g., S2-fiberglass), or a combination thereof. The impact resistant layers 402, 403 can also comprise the same material and/or different material. For example, the first impact resistant layer 402 can include Nextel™ and the second impact resistant layer 403 can include Kevlar® In another embodiment, the first impact resistant layer 402 can include Kevlar® and the second impact resistant layer 403 can include Nextel™. In another embodiment, the first impact resistant layer 402 can include Nextel™ or Kevlar® and the second impact resistant layer 403 can include fiberglass. Alternatively, the first impact resistant layer 402 can include fiberglass and the second impact resistant layer 403 can include Nextel™ or Kevlar®. In some embodiments, the impact resistant layers 402, 403 each include Nextel™, each include Kevlar®, or each include fiberglass.

The front face sheet 401 can include a metal matrix composite material or fiberglass (e.g., S2-fiberglass). The fiberglass can include multiple fiberglass sheets and/or plies, e.g., the front face sheet 401 can include 2, 3, 4, 5, 6, 7, 8, 9, or 10 fiberglass sheets and/or plies. The thickness of the fiberglass sheets and/or ply can be about 0.8 inches, about 0.9 inches, about 1 inch, about 1.1 inches, or about 1.2 inches.

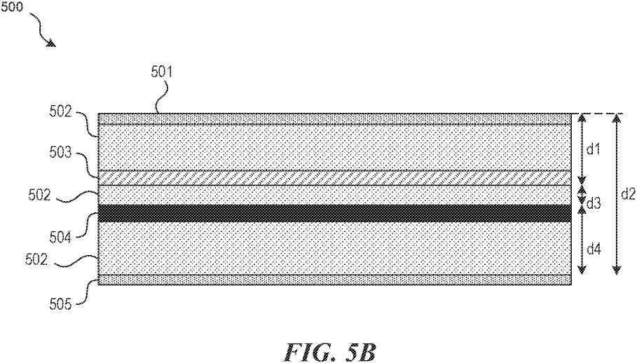

FIGS. 5A-5B are schematic cross-sectional views of a representative MMOD protection structure 500 configured in accordance with embodiments of the present technology. In the illustrated embodiment, the MMOD protection structure 500 includes a front face sheet 501 and a rear face sheet 505, in which the rear face sheet 505 comprises either an exterior wall of a space vehicle or a face sheet bonded to an exterior wall of a space vehicle. Intermediate layers are positioned between the front face sheet 501 and rear face sheet 505, and can include a first impact resistant layer 503, and a second impact resistant layer 504 positioned between two or more absorption core layers 502. The first impact resistant layer 503 and the second impact resistant layer 504 can paired together and positioned between two absorption core layers 502 (as shown in FIG. 5A), or, in another embodiment, the first impact resistant layer 503 and the second impact resistant layer 504 can be separated by an additional absorption core layer 502, and then positioned between two absorption core layers 502 as shown in FIG. 5B.

When the first impact resistant layer 503 and the second impact resistant layer 504 are adjacent to each other as shown in FIG. 5A, the distance (d1) between the first impact resistant layer 503 and the front face sheet 501 can be about 1 inch, about 2 inches, about 3 inches, or about 4 inches. Similarly, a distance (d1) between the second impact resistant layer 504 and the rear face sheet 505 can be about 1 inch, about 2 inches, about 3 inches, or about 4 inches. In some embodiments, d1 is 3 inches. In another embodiment, d1 is 2 inches.

When the first impact resistant layer 503 and the second impact resistant layer 504 are separated by an additional absorption core layer 502, and then positioned between two absorption core layers 502 as shown in as shown in FIG. 5B, the distance (d1) between the first impact resistant layer 503 and the front face sheet 501 can be about 1 inch, about 1.5 inches, about 2 inches, about 2.5 inches, about 3 inches, about 3.5 inches or about 4 inches. The distance (d3) between the first impact resistant layer 503 and the second impact resistant layer 502, also corresponding to the thickness of the absorption foam layer 502 positioned between the first impact resistant layer 503 and the second impact resistant layer 502, can be about 0.3 inches, about 0.4 inches, about 0.5 inches, about 0.6 inches, about 0.7 inches, about 0.8 inches, about 0.9 inches, about 1 inch, about 1.1 inch, or about 1.2 inches. The distance (d4) between the second impact resistant layer 504 and the rear face sheet 505 can be about 1.5 inches, about 2 inches, about 2.5 inches, about 3 inches, about 3.5 inches, or about 4 inches. In some embodiments, d1 is 1.5 inches, d3 is 0.5 inches, and d4 is about 2 inches. In another embodiment, d1 is 1.5 inches, d3 is 1 inch, and d4 is about 1.5 inches.

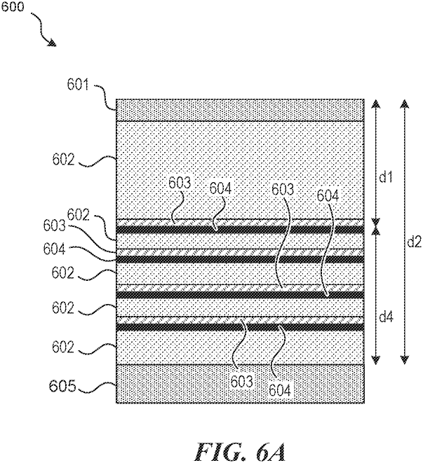

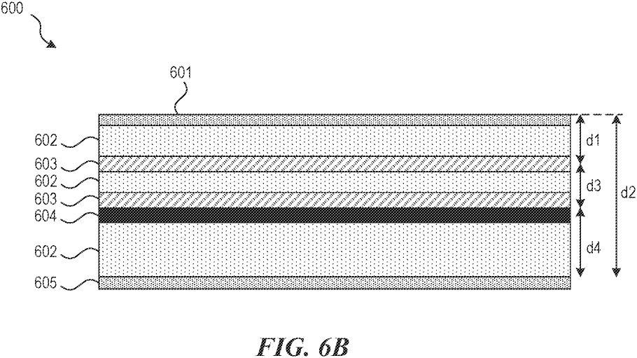

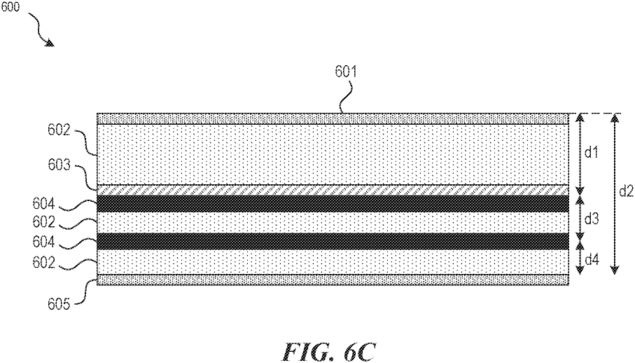

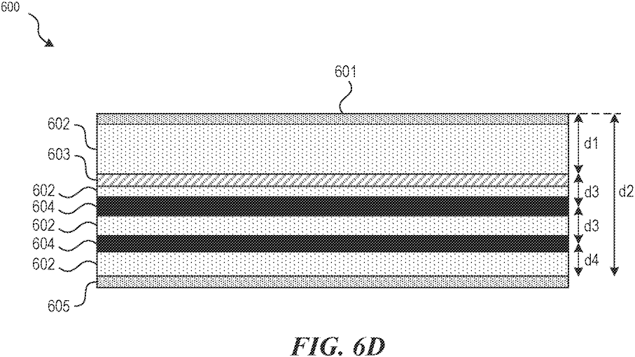

FIGS. 6A-6D are schematic cross-sectional views of a representative MMOD protection structure 600 configured in accordance with embodiments of the present technology. In the illustrated embodiment, the MMOD protection structure 600 includes a front face sheet 601 and a rear face sheet 605, in which the rear face sheet 605 comprises either an exterior wall of a space vehicle or a face sheet bonded to an exterior wall of a space vehicle. Intermediate layers are positioned between the front face sheet 601 and rear face sheet 605, and can include a plurality of impact resistant layers comprising at least one first impact resistant layer 603 and at least one second impact resistant layer 604 positioned between a plurality of absorption core layers 602. The impact resistant layers 603, 604 can be paired together, for example with each pair is spaced apart from a neighboring pair by an absorption core layer 602 (as shown in FIG. 6A). In another embodiment, similar impact resistant layers can be separated by an absorption core layer 602, for example, a first impact resistant layer 603 can be separated from another first impact resistant layer 603 (as shown in FIG. 6B) or a second impact resistant layer 604 can be separated from another second impact resistant layer 604 (as shown in FIG. 6C). In yet another embodiment, each of the impact resistant layers 603, 604 are separated by an absorption core layer 602 (as shown in FIG. 6D).

Referring to FIGS. 6A-6D, a distance (d3) between the impact resistant layers 603, 604, also corresponding to a thickness of a corresponding intermediate absorption core layer 602, can be about 0.5 inches, about 1 inch, about 1.5 inches, about 2 inches, about 2.5 inches, or about 3 inches. A distance (d1) between the impact resistant layers 603, 604 and the front face sheet can be about 0.5 inches, about 1 inch, about 1.5 inches, about 2 inches, about 2.5 inches, about 3 inches, about 3.5 inches, or about 4 inches. A distance (d4) between the impact resistant layers 603, 604 and the rear face sheet 605 can be about 0.5 inches, about 1 inch, about 1.5 inches, about 2 inches, about 2.5 inches, about 3 inches, or about 4 inches.

The MMOD protection structures 500 and 600 can also include those features described above with respect to FIG. 4. For example, a stand-off distance (d2), a thickness of the front and rear face sheets, relative dimensions of the front face sheets to the remaining layers (e.g., absorption core layers, impact resistant layers, and rear face sheet), the composition of the impact resistant layers, and the composition of the front face sheet are the same as described above with respect to FIG. 4.

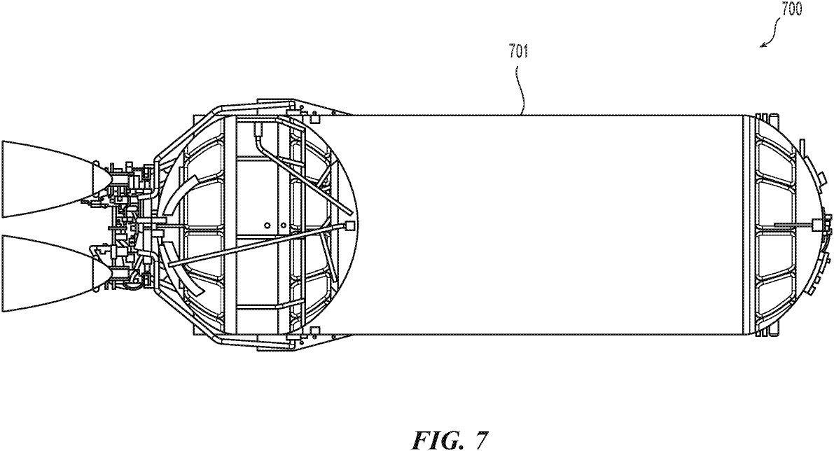

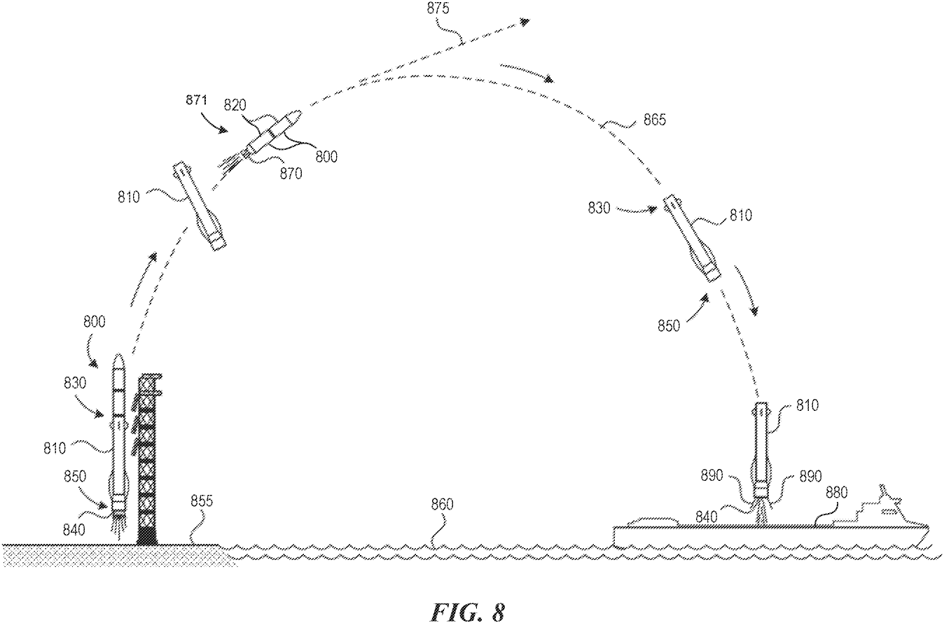

FIG. 7 is a schematic diagram of a space vehicle 700 where at least a portion of the space vehicle includes a bonded MMOD protection structure 701 shown on the body of the space vehicle. The MMOD protection structure can be bonded by either adhesive bonding or mechanical fastening. In some embodiments, the MMOD protection structure comprises a front face sheet and a rear face sheet, where the rear face sheet is bonded to the space vehicle via an expandable adhesive foam layer. The expandable adhesive foam layer can help to fill gaps between the rigid structure of the MMOD protection structure and the space vehicle. In some embodiments, the exterior wall of the space vehicle serves as the rear face sheet and the underlying MMOD protection structure is directly bonded, via either adhesive bonding or mechanical fastening, to the exterior wall of the space vehicle.

FIG. 8 is a schematic diagram illustrating a representative mission profile of an aerospace system including a space vehicle 800 (e.g., including a launch vehicle), in which at least a portion of the vehicle can include a bonded MMOD protection structure that is exposed both during launch and in space. The space vehicle 800 can include multiple portions (e.g., stages), such as a first or booster stage 810 and one or more second or upper stages 820 (two are shown in FIG. 8). The booster stage 810 includes a forward end 830 and one or more rocket engines 840 (including one or more exhaust nozzles) positioned toward an aft (tail) end 850. The space vehicle 800 can be a space launch vehicle for carrying humans and/or cargo to space or it can be a launch vehicle for moving humans and/or cargo within the Earth’s atmosphere (e.g., at hypersonic speeds). Accordingly, although reference may be made to orbital space, embodiments of the present technology may be used with portions (e.g., stages) of launch vehicles that carry out suborbital missions.

Although the upper stage(s) 820 are stacked on top of the booster stage 810 in the illustrated mission profile, in other embodiments the space vehicle 800 and variations thereof can have other configurations without departing from the present disclosure. For example, the upper stage(s) 820 and the booster stage 810 can be positioned side-by-side and attached to each other during ascent with a suitable separation system. In another example, two or more booster stages 810 or variations thereof can be positioned around an upper stage 820 in a “strap-on” type configuration. Accordingly, the present disclosure is not limited to the particular launch vehicle configuration illustrated in FIG. 8.

In the illustrated example, the space vehicle 800 takes off from a coastal or other land-based launch site 855 and then turns out over a body of water 860 (such as an ocean). At some point, such as after a high-altitude booster engine cutoff (BECO) operation, the booster stage 810 separates from the second (e.g., upper) stage(s) 820 and continues along a ballistic trajectory 865. The second (e.g., upper) stage(s) 820 can include a propulsion system 871 having one or more engines 870 that ignite and propel the second stage(s) 820 during launch into a higher trajectory 875 for orbital insertion or other destinations or activities.

The booster stage 810 reenters the Earth’s atmosphere before or after reorienting so that the aft end 850 is pointing in the direction of motion (tail-first). The booster stage 810 descends toward a landing platform 880, which can be a floating (e.g., sea-going) platform, although it can alternatively be a fixed platform on land (for example, the mission can take place entirely over land, or over a combination of land and water). The booster stage 810 can land tail-first on the landing platform 880 using thrust from the one or more rocket engines 840. The booster stage 810 can carry one or more landing support elements 890, which can include suitable shock-absorbing landing gear (e.g., one or more landing legs). The landing support elements 890 can support the booster stage 810 in an upright position after landing. In response to landing, upon landing, or after landing (such as shortly after landing), the landing support elements 890 can be fastened to the landing platform 880 in accordance with embodiments of the present disclosure.

The MMOD protection systems discussed herein have particular applicability to any of the components positioned above the initial booster state 810 - e.g., any components that are subjected to both launch loads and the MMOD exposure. Accordingly, any of these components (e.g., the upper stage(s) 820 and/or other payloads) operates as a space vehicle. In a particular example, an upper stage 820 includes a propulsion system 871 (e.g., rocket engines 871 and onboard fuel). After the upper stage is in space (e.g., on orbit), the propulsion system 871 can be deactivated, and the upper stage 871 used as a habitat, under the protection of an MMOD protection system 300 having any of the characteristics described above.

One feature of several of the embodiments described above with reference to FIGS. 1-9, and with other embodiments configured according to the present disclosure, is that the MMOD structure can include face sheets comprising a metal matrix composite, a polymer composite, and/or a metal sheet. Metal matrix composites, polymer composites, and/or metal sheets have a high specific strength and can impart protection to the space launch vehicle from MMOD by dissipating forces created by the MMOD upon impact. Another feature is the use of a low density, energy absorption core layer, which can effectively lower the velocity of MMOD upon impact with the MMOD protection system. The absorption core layer can also include perforated foam, which can serve to reduce the mass of the MMOD protection system. For example, as discussed above, the use of foam as part of composite sandwich structure can reduce mass, and perforating the foam can further reduce mass. In addition, the face sheet materials are selected for both light mass and high strength/impact resistance. Yet another feature is that the MMOD protection system can include an expandable foam adhesive to bond the MMOD protection system to a space launch vehicle. The expandable foam adhesive can increase the performance of the MMOD protection system by allowing the MMOD protection structure to withstand dynamic and static loads experienced by the space vehicle at the time of launch. Generally, embodiments of the present technology provide a MMOD protection system that enables launch of a space vehicle into space without fear of structural damage.

Still further, the MMOD material can be applied directly to the spacecraft on the ground, and can provide protection against not only MMOD, but also the thermal and pressure loads experienced during launch. This in turn can eliminate the need for a fairing, which further reduces system mass. Put another way, using an MMOD structure in accordance with the present technology can reduce the overall mass of the entire system (and/or allow for more payload and/or more fuel), without sacrificing MMOD resistance, and without requiring that the MMOD be applied to the vehicle in space. The result is a more efficient system, without adding extravehicular manufacturing steps.

The above detailed description of embodiments of the present technology is not intended to be exhaustive or to limit the technology to the precise forms disclosed above. Although specific embodiments of, and examples for, the technology are described above for illustrative purposes, various equivalent modifications are possible within the scope of the present technology. The various embodiments described herein may also be combined to provide further embodiments.

From the foregoing, it will be appreciated that specific embodiments of the technology have been described herein for purposes of illustration, but well-known structures and/or functions have not been shown or described in detail to avoid unnecessarily obscuring the description of the embodiments of the technology. Where the context permits, singular or plural terms may also include the plural or singular term, respectively.

As used herein, the phrase “and/or” as in “A and/or B” refers to A alone, B alone, and A and B. The terms “about” and “approximately” refer to values within 10% of the stated value. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/we claim:

1. A space system, comprising:
a space vehicle having a sub-structure, and further having an external surface configured to be exposed to both an atmospheric environment during launch and an exo-atmospheric environment after launch, the external surface being formed, at least in part, by a micrometeoroid and orbital debris (MMOD) protection system, the MMOD protection system including:
(a) a front face sheet and a rear face sheet spaced apart from the front face sheet, the front face sheet facing outwardly and forming at least a portion of the external surface, and the rear face sheet being attached to the sub-structure;
(b) at least one absorption core layer and at least one impact resistant fabric layer positioned between the front face sheet and the rear face sheet; and
(c) an expandable adhesive layer carried by the rear face sheet and attached between the rear face sheet and the sub-structure to secure the MMOD protection system to the sub-structure,
wherein the front face sheet and the rear face sheet comprise a metal matrix composite, polymer composite, metal sheet, or combination thereof.

2. The space system of claim 1, wherein the at least one absorption core layer includes a plurality of absorption core layers, and the at least one impact resistant fabric layer includes a plurality of impact resistant fabric layers, and wherein individual absorption core layers are alternated with individual impact resistant layers.

3. The space system of claim 1, wherein the metal matrix composite includes an aluminum matrix composite.

4. The space system of claim 1, wherein the polymer composite comprises fiberglass reinforced epoxy composites.

5. The space system of claim 1, wherein the metal sheet comprises aluminum or an alloy thereof.

6. The space system of claim 1, wherein the at least one absorption core layer comprises foam, honeycomb material, or combination thereof.

7. The space system of claim 6, wherein the foam includes perforated foam.

8. The space system of claim 6, wherein the foam comprises polyurethane foam.

9. The space system of claim 1, wherein the at least one impact resistant fabric layer comprises a ceramic oxide fiber, an aramid fiber, a polyethylene fiber, or a combination thereof.

10. The space system of claim 1, wherein a distance from the front face sheet to the sub-structure is about 4 inches.

11. The space system of claim 1, wherein the space vehicle includes a payload, and wherein the payload includes at least one of a space station component, an orbital storage facility, an orbital habitat, an interplanetary spacecraft, or a rocket stage.

12. The space system of claim 11, wherein the sub-structure forms a portion of the payload, and wherein the MMOD is attached to the sub-structure of the payload.

13. The space system of claim 1, wherein the space vehicle includes a payload, and wherein the space system does not include a removeable fairing around the payload at launch.

14. The space system of claim 1, wherein the space vehicle includes an orbital habitat, and wherein the space system does not include a removable fairing around the orbital habitat at launch.

15. The space system of claim 14, wherein the orbital habitat includes a launch propulsion system activatable to propel the space system during launch.

16. A method for operating a space system, comprising:
launching a space vehicle through the atmosphere, the space vehicle having a sub-structure, and further having an external surface exposed to the atmosphere during launch, the external surface being formed, at least in part, by a micrometeoroid and orbital debris (MMOD) protection system, the MMOD protection system including:
(a) a front face sheet and a rear face sheet spaced apart from the front face sheet, the front face sheet facing outwardly and forming at least a portion of the external surface, and the rear face sheet being attached to the sub-structure;
(b) at least one absorption core layer and at least one impact resistant fabric layer positioned between the front face sheet and the rear face sheet; and
(c) an expandable adhesive layer carried by the rear face sheet and attached between the rear face sheet and the sub-structure to secure the MMOD protection system to the sub-structure, wherein the front face sheet and the rear face sheet comprise a metal matrix composite, polymer composite, metal sheet, or combination thereof; and
directing the space vehicle out of the atmosphere and into space with the MMOD protection system attached.

17. The method of claim 16, wherein launching the space vehicle includes launching the space vehicle without a fairing positioned around a payload of the space vehicle.

18. The method of claim 17, wherein the payload includes at least one of a space station component, an orbital habitat, an orbital storage facility, an interplanetary spacecraft, or a rocket stage.

19. The method of claim 18, wherein the payload includes an orbital habitat.

20. The method of claim 19, wherein the orbital habitat includes a launch propulsion system, and wherein the method further comprises:
activating the launch propulsion system during launch;
deactivating the launch propulsion system after launch; and
converting the orbital habitat for human occupation when the orbital habitat is in orbit.

21. The method of claim 16, wherein the at least one absorption core layer includes a plurality of absorption core layers, and the at least one impact resistant fabric layer includes a plurality of impact resistant fabric layers, and wherein individual absorption core layers are alternated with individual impact resistant layers.

22. The space system of claim 16, wherein the metal matrix composite includes an aluminum matrix composite.

23. The space system of claim 16, wherein the polymer composite comprises fiberglass reinforced epoxy composites.

24. The space system of claim 16, wherein the metal sheet comprises aluminum or an alloy thereof.

25. The space system of claim 16, wherein the at least one absorption core layer comprises foam, honeycomb material, or combination thereof.

26. The space system of claim 25, wherein the foam includes perforated foam.

27. The space system of claim 25, wherein the foam comprises polyurethane foam.

28. The space system of claim 16, wherein the at least one impact resistant fabric layer comprises a ceramic oxide fiber, an aramid fiber, a polyethylene fiber, or a combination thereof.

29. The space system of claim 16, wherein a distance from the front face sheet to the sub-structure is about 4 inches.

30. A method for manufacturing a space system, comprising:
positioning a micrometeoroid and orbital debris (MMOD) protection system proximate to a sub-structure of a space vehicle, the MMOD protection system including:
(a) a front face sheet and a rear face sheet spaced apart from the front face sheet, the front face sheet being directed outwardly and forming at least a portion of an external surface of the space vehicle, the front face sheet and the rear face sheet comprising a metal matrix composite; and
(b) at least one absorption core layer and at least one impact resistant fabric layer positioned between the front face sheet and the rear face sheet; and
attaching the MMOD protection system to the sub-structure via an expandable adhesive layer positioned between the rear face sheet and the sub-structure, with the front face sheet positioned to be exposed during launch, and unprotected by a fairing.

31. The method of claim 30, wherein:
the space vehicle includes a payload;
the sub-structure forms a portion of the payload; and
the MMOD is attached to the sub-structure of the payload.

32. The method of claim 30, wherein the payload includes at least one of a space station, orbital storage facility, orbital habitat, interplanetary spacecraft, or rocket stage.

33. The method of claim 32, wherein the payload includes an orbital habitat.

34. The method of claim 33, wherein the orbital habitat includes a launch propulsion system activatable to propel the space system during launch.
